(19) United States
(12) Patent Application Publication
(10) Pub. No.: US 2026/0054263 A1
(43) Pub. Date: Feb. 26, 2026

(54) LIQUID COLLECTION CONTAINER AND LIQUID COMPONENT EXTRACTION SYSTEM

(71) Applicant: Sanplatec Corporation Ltd., Osaka-shi, Osaka (JP)

(72) Inventors: Satoshi KATOU, Osaka-shi, Osaka (JP); Junichi KUWABARA, Osaka-shi, Osaka (JP); Daiki KAWATA, Osaka-shi, Osaka (JP)

(21) Appl. No.: 18/996,493

(22) PCT Filed: Apr. 21, 2023
(86) PCT No.: PCT/JP2023/015907

§ 371 Date: Jan. 17, 2025

(51) Int. Cl. B01L 3/00

(52) U.S. Cl. CPC B01L 3/502; B01L 2300/0832; B01L 2400/0478; B01L 2400/0622

(57) ABSTRACT

Provided is a liquid collection container that allows collected liquid to be extracted in a closed state. A liquid collection container A1 includes: a container body 1 including a cylindrical portion 11 that extends in a first direction x; a gasket 2 that is in close contact with an inner peripheral surface of the cylindrical portion 11 without any gaps in a circumferential direction, thereby forming a first space S1 inside the container body 1; a closure wall 12, a first plug portion 3, and a passage tube 4 (first switching portion) located at an end of the first cylindrical portion on a first side x1 in the first direction and switchable between a state where the first space S1 communicates with an outside and a state where the first space S1 does not communicate with the outside; and a plunger 5 connected to the gasket 2, extending from an opening 111 of the first cylindrical portion 11 at an end on a second side x2 in the first direction to the second side x2 in the first direction, and capable of applying a force for sliding the gasket 2 in the first direction x. The closure wall 12 closes the end of the first cylindrical portion 11 on the first side x1 in the first direction, and includes a communication hole 121 penetrating through in the first direction x. The first plug portion 3 includes a first connecting portion 31 that is impermeable with respect to gas and liquid-tight. The passage tube 4 includes a first end portion 41 connected to the closure wall 12 in a state where the first end portion 41 is in communication with the communication hole 121, and a second end portion 42 closed by the first connecting portion 31.

### TECHNICAL FIELD

The present disclosure relates to a liquid collection container for collecting liquid, and a liquid component extraction system including the liquid collection container.

### BACKGROUND ART

A container called a vacuum blood collection tube has been widely used to collect blood for testing. The vacuum blood collection tube includes a main body, which has a conical bottom wall made of plastic or glass and a cylindrical side wall standing from the periphery of the bottom wall, and a rubber-like plug closing an opening of the main body (see Patent document 1, for example). The plug may be a sheet containing aluminum, and only a needlestick portion may be made of rubber. The inside of the vacuum blood collection tube is maintained at a depressurized state, and blood can flow into the blood collection tube directly from another container or a vein in a body upon causing a needle to penetrate through the rubber portion of the plug.

Such a standard vacuum blood collection tube as described above is mainly used for blood testing, and in most cases, blood is introduced into the blood collection tube and mixed with a reagent preloaded inside the tube to obtain the testing result. If the collected blood needs to be transferred into another container, the plug is opened and the blood is sucked via an instrument.

In particular, when some of the blood components are to be used as the raw materials of iPS cells for regenerative medicine or the like, the vacuum blood collection tube containing the whole blood sample is subjected to centrifugal separation so as to separate the blood sample into blood components and to suck and collect only the necessary components. However, the main body of the vacuum blood collection tube is made of a hard material in order to maintain a depressurized state until the blood collecting process. Accordingly, if suction is conducted from the tube, which is communicated with the outside by the needle penetrating through the plug, it is difficult to collect the liquid contained in the blood collection tube due to pressure resistance. In this case, it is necessary to open at least a portion of the plug and suck the liquid with an instrument. However, this requires a high-level sterile facility and a special technique in order to keep the sterility of the raw materials, and increased costs for facility maintenance, labor, etc., will ultimately lead to a higher product price.

### PRIOR ART DOCUMENT

### Patent Document

Patent Document 1: JP-A-2008-264066

### SUMMARY OF THE INVENTION

### Problem to be Solved by the Invention

In view of the foregoing circumstances, a main object of the present disclosure is to provide a liquid collection container that allows collected liquid to be extracted in a closed state.

### Means to Solve the Problem

In order to solve the above problem, the following technical means are employed in the present disclosure.

Provided by a first aspect of the present disclosure, a liquid collection container includes: a container body including a first cylindrical portion that extends in a first direction; a gasket that is in close contact with an inner peripheral surface of the first cylindrical portion without any gaps in a circumferential direction, thereby forming a first space inside the container body; a first switching portion located at an end of the first cylindrical portion on a first side in the first direction and switchable between a state where the first space communicates with an outside and a state where the first space does not communicate with the outside; and a plunger connected to the gasket, extending from an opening of the first cylindrical portion at an end on a second side in the first direction to the second side in the first direction, and capable of applying a force for sliding the gasket in the first direction. The first switching portion includes a closure portion and at least a pair of a first plug portion and a passage tube. The closure portion closes the end of the first cylindrical portion on the first side in the first direction, and has at least one communication hole penetrating through in the first direction. The first plug portion includes a first connecting portion that is impermeable with respect to gas and liquid-tight. The passage tube includes a first end portion connected to the closure portion in a state where the first end portion is in communication with the communication hole, and a second end portion closed by the first connecting portion.

Provided by a second aspect of the present disclosure, a liquid component extraction system is configured with elements connected in a closed manner. The liquid component extraction system includes: the liquid collection container according to the first aspect of the present disclosure; a power function unit that moves the gasket in the first direction by applying a force for pushing and pulling the plunger of the liquid collection container; a second plug portion connectable to the first plug portion of the liquid collection container; a first passage connected to the second plug portion at one end; and a liquid storage container connected to another end of the first passage and for storing a component located in the first space of the container body.

Other features and advantages of the present disclosure will be more apparent from the detailed description given below with reference to the accompanying drawings.

### BRIEF DESCRIPTION OF THE DRAWINGS

FIG. 1 is a front view showing a liquid collection container according to a first embodiment of the present disclosure.

FIG. 2 is a longitudinal cross-sectional view showing the liquid collection container in FIG. 1.

FIG. 3 shows the state where the liquid collection container in FIG. 2 contains a density gradient medium.

FIG. 4 is a longitudinal cross-sectional view showing a use state of the liquid collection container according to the first embodiment of the present disclosure.

FIG. 5 is a longitudinal cross-sectional view showing a use state of the liquid collection container according to the first embodiment of the present disclosure.

FIG. 6 is a longitudinal cross-sectional view showing a use state of the liquid collection container according to the first embodiment of the present disclosure.

FIG. 7 shows a schematic configuration of a liquid component extraction system according to the first embodiment of the present disclosure.

FIG. 8 is a view for explaining a method for using the liquid component extraction system according to the first embodiment of the present disclosure.

FIG. 9 is a longitudinal cross-sectional view similar to FIG. 2, showing a liquid collection container according to a second embodiment of the present disclosure.

FIG. 10 is a longitudinal cross-sectional view similar to FIG. 2, showing a liquid collection container according to a third embodiment of the present disclosure.

FIG. 11 is a longitudinal cross-sectional view similar to FIG. 2, showing a liquid collection container according to a fourth embodiment of the present disclosure.

FIG. 12 is a longitudinal cross-sectional view showing a use state of the liquid collection container according to the fourth embodiment of the present disclosure.

FIG. 13 shows a schematic configuration of a liquid component extraction system according to the second embodiment of the present disclosure.

FIG. 14 shows a schematic configuration of a liquid component extraction system according to the third embodiment of the present disclosure.

### MODE FOR CARRYING OUT THE INVENTION

The following describes preferred embodiments of the present disclosure in detail with reference to the drawings.

The terms such as “first”, “second” and “third” in the present disclosure are used merely as labels and not intended to impose orders on the elements accompanied with these terms.

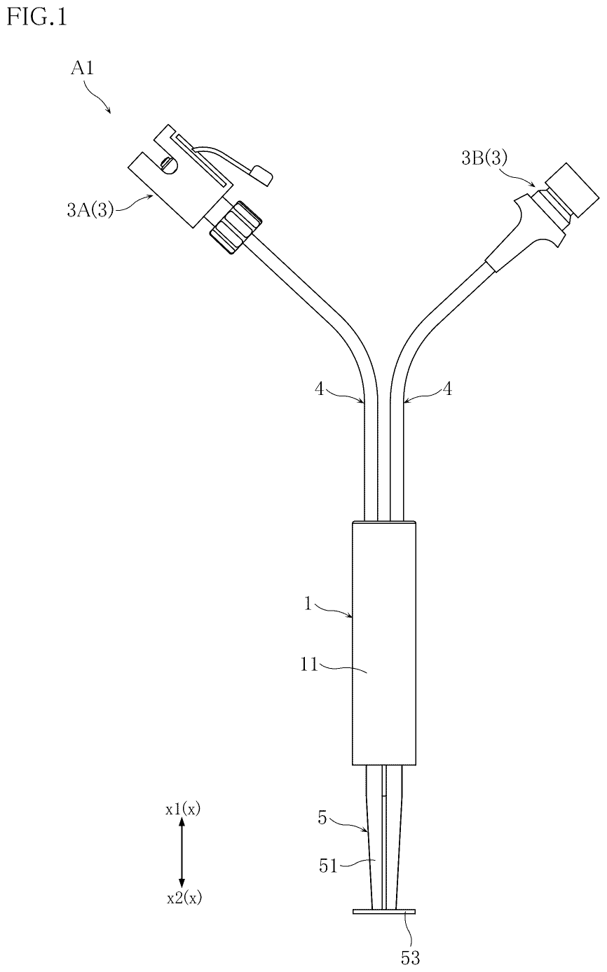

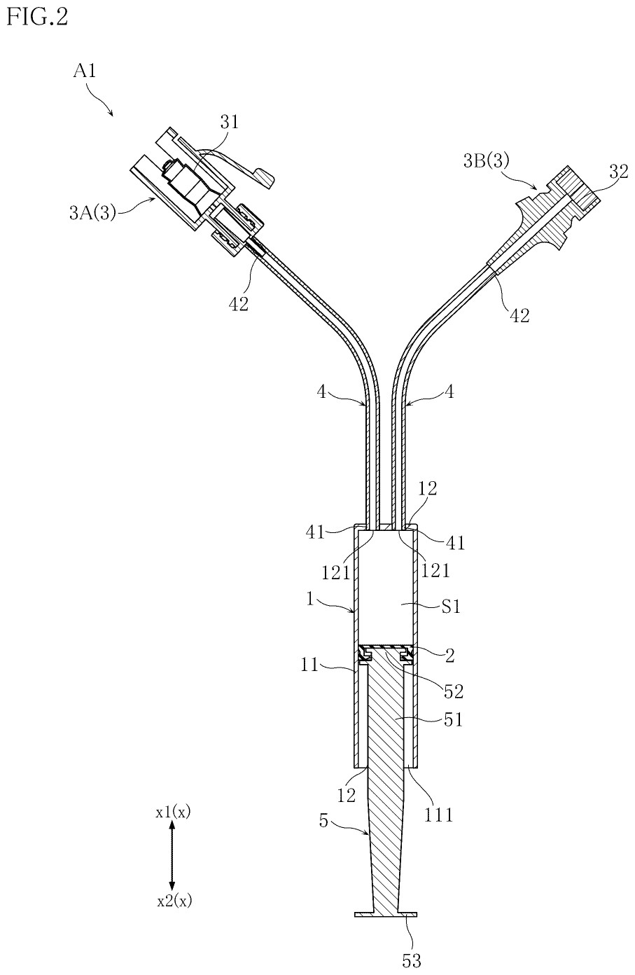

FIGS. 1 to 3 show a liquid collection container according to a first embodiment of the present disclosure. A liquid collection container A1 according to the present embodiment includes a container body 1, a gasket 2, a plurality of first plug portions 3, a plurality of passage tubes 4, and a plunger 5. The liquid collection container A1 according to the present embodiment may be used when blood is collected and white blood cells including mononuclear cells in the blood are separated from other components by centrifugal separation and collected. FIG. 1 is a front view showing the liquid collection container A1. FIG. 2 is a longitudinal cross-sectional view showing the liquid collection container A1.

In the present embodiment, the container body 1 has a first cylindrical portion 11 and a closure wall 12. The first cylindrical portion 11 has a substantially cylindrical shape, and extends in a first direction x. The closure wall 12 closes the first cylindrical portion 11 at the end on a first side in the first direction x (hereinafter referred to as “the end on a first side x1 in the first direction” as appropriate. The closure wall 12 has a communication hole 121. The communication hole 121 penetrates through in the first direction x. In the illustrated example, the closure wall 12 has two communication holes 121. The first cylindrical portion 11 has an opening 111 at the end on a second side in the first direction x (hereinafter referred to as “the end on a second side x2 in the first direction” as appropriate).

The gasket 2 is fitted in the first cylindrical portion 11, and is in close contact with the inner peripheral surface of the first cylindrical portion 11 without any gaps in the circumferential direction. The gasket 2 is made of a rubber material having suitable elasticity, for example. The shape of the gasket 2 is not particularly limited. In the illustrated example, two annular protrusions at the outer periphery are aligned in the first direction x and connected to each other. The constituent material of the gasket 2 is not particularly limited, and may be a thermoplastic elastomer (TPE), for example. The gasket 2 forms a first space S1 that is closed inside the first cylindrical portion 11 (the container body 1). The first space S1 is located on the first side x1 in the first direction with respect to the gasket 2. The gasket 2 is capable of sliding in the first direction x while being in close contact with the inner peripheral surface of the first cylindrical portion 11 without any gaps.

The first plug portions 3 and the passage tubes 4 are arranged at the end of the first cylindrical portion 11 on the first side x1 in the first direction.

Regarding the first plug portions 3 and the passage tubes 4, one of the first plug portions 3 and one of the passage tubes 4 are grouped as a pair, and the liquid collection container A1 includes at least a pair of a first plug portion 3 and a passage tube 4. In the present embodiment, the liquid collection container A1 includes two pairs of first plug portions 3 and passage tubes 4 (i.e., two first plug portions 3 and two passage tubes 4). In the illustrated example, the two first plug portions 3 have different structures. In the following description, the first plug portion 3 shown on the left side of FIGS. 1 to 3, etc., is referred to as “a first plug portion 3A” as appropriate, and the first plug portion 3 shown on the right side of FIGS. 1 to 3, etc., is referred to as “a first plug portion 3B” as appropriate to distinguish them from each other.

In the illustrated example, the first plug portion 3A is configured as a portion of a needleless connector. Specifically, the first plug portion 3A is one of a pair of connector portions of the needleless connector, and has a first connecting portion 31. The first connecting portion 31 has a valve structure that can switch between an open state and a closed state. The first connecting portion 31 is closed when the first plug portion 3A is not connected to a connector (as shown in FIG. 2), and opens when the first plug portion 3A is connected to a connector. The shape, etc., of the first stopper 3A is not limited to the example shown in the figure.

In the illustrated example, the first plug portion 3B is configured as a portion of a needleless connector. The first plug portion 3B is one of a pair of connector portions of the needleless connector, and has a first connecting portion 32. The first connecting portion 32 has a valve structure that can switch between an open state and a closed state. The first connecting portion 32 is closed when the first plug portion 3B is not connected to a connector (as shown in FIG. 2), and opens when the first plug portion 3B is connected to the connector. In the illustrated example, the first plug portion 3B is a connector portion connectable to the first plug portion 3A. The shape of the first plug portion 3B is not limited to the example shown in the figure.

Each of the passage tubes 4 is a fluid passage connecting the closure wall 12 and a first plug portion 3 (the first plug portion 3A or the first plug portion 3B), and is made of a flexible material, for example. Each of the passage tubes 4 has a first end portion 41 and a second end portion 42 at its respective ends. The first end portion 41 is fitted in a communication hole 121 of the closure wall 12, for example, and the first end portion 41 and the closure wall 12 are hermetically connected by an appropriate means such as adhesion. The first end portion 41 is connected to the closure wall 12 in a state that allows the first end portion 41 to communicate with the communication hole 121, and the inside of the passage tube 4 is in communication with the first space S1 of the first cylindrical portion 11 (the container body 1).

The second end portion 42 is hermetically connected to an end of a first plug portion 3 (the first plug portion 3A or 3B) by an appropriate means such as adhesion. As shown in FIG. 2, when the first plug portion 3A (3B) is not connected to a connector, the inside of the passage tube 4 is shut off from the outside by the first connecting portion 31 (32) and is not in communication with the outside.

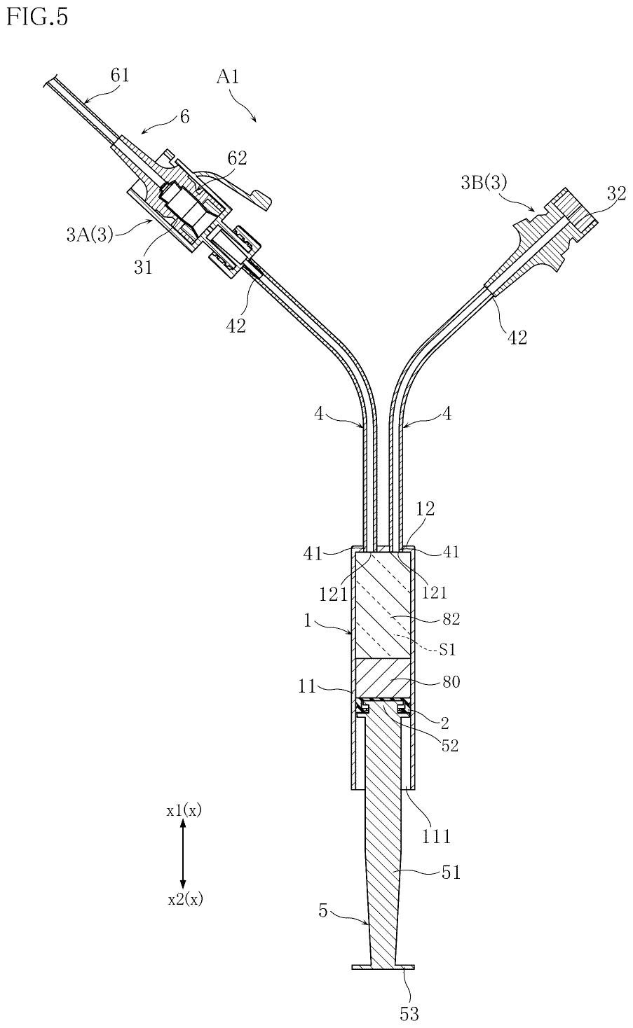

In the state shown in FIG. 2, the first space S1 of the container body 1 is not in communication with the outside by means of the closure wall 12 and the two pairs of first plug portions 3 and passage tubes 4 having the configurations described above. On the other hand, the first space S1 of the container body 1 can communicate with the outside via a passage tube 4 by, for example, connecting a connector portion (e.g., a connector portion 62 of a connection tool 6 described below with reference to FIG. 5). The closure wall 12 and the two pairs of first plug portions 3 and passage tubes 4 are examples of the elements of a “first switching portion”. The two pairs of first plug portions 3 and passage tubes 4 may be handled as a single assembly.

The plunger 5 applies force to slide the gasket 2 in the first direction x. The plunger 5 is connected to the gasket 2, and extends from the opening 111 of the container body 1 (the first cylindrical portion 11) at the end on the second side x2 in the first direction to the second side x2 in the first direction. In the illustrated example, the plunger 5 has a shaft portion 51, a leading end portion 52, and a trailing end portion 53. The shaft portion 51 is elongated in the first direction x. The leading end portion 52 is located at the end of the shaft portion 51 on the first side x1 in the first direction, and the gasket 2 is attached to the shaft portion 51. The trailing end portion 53 is located at the end of the shaft portion 51 on the second side x2 in the first direction, and has a flange shape extending radially outward from the shaft portion 51.

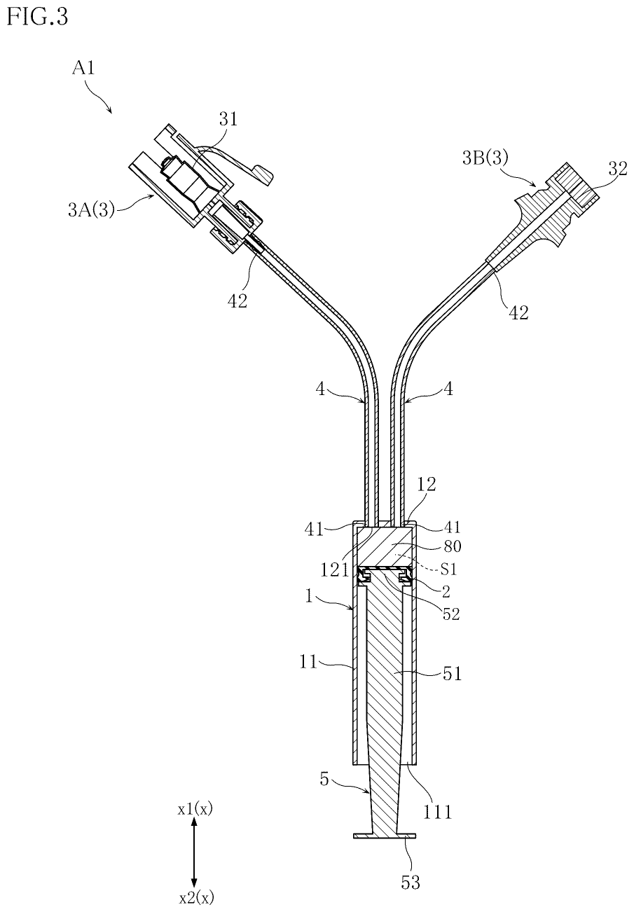

In the liquid collection container A1 of the present embodiment, a density gradient medium 80 is stored in the first space S1 of the container body 1, as shown in FIG. 3. The density gradient medium 80 is located on the first side x1 in the first direction relative to the gasket 2. The density gradient medium 80 is used to separate a specific component in blood. In the present embodiment, the density gradient medium 80 used is suitable for separating plasma, white blood cells including mononuclear cells, and red blood cells in blood. If necessary, a blood anticoagulant may be additionally provided in the first space S1 of the container body 1.

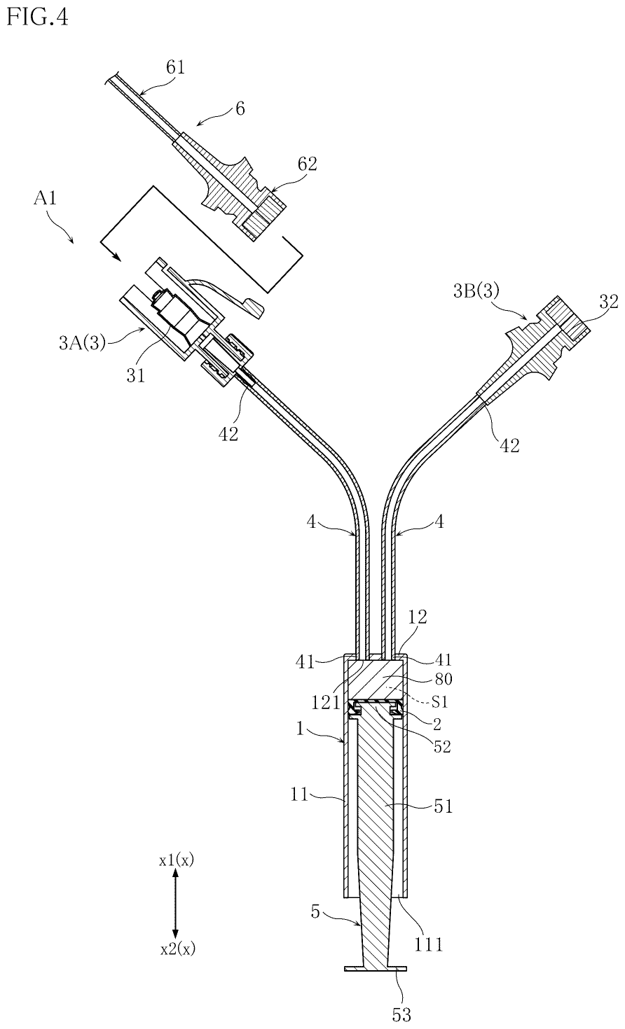

Next, the use and advantages of the liquid collection container A1 will be described with reference to FIGS. 4 to 8.

The liquid collection container A1 is used to collect blood into the container body 1, separate white blood cells including mononuclear cells in the blood from other components by centrifugal separation, and collect the white blood cells including mononuclear cells.

As shown in FIGS. 4 and 5, when blood is collected in the container body 1 of the liquid collection container A1, the connector portion 62 may be connected to the first plug portion 3A (the first connecting portion 31). The connector portion 62 is arranged at one end of the connection tool 6 having a tube 61, and is connectable to the first plug portion 3A. A blood bag containing blood collected from a human body, for example, is connected to the other end of the connection tool 6 having the tube 61. The first connecting portion 31 is open when the connector portion 62 is connected to the first plug portion 3A. Next, when the plunger 5 is pulled out to the second side x2 in the first direction, the blood flows into the first space S1 from the blood bag (located outside), so that the blood can be collected. Note that the connection tool 6 is not limited to the configuration where the blood bag is connected to the other end of the connection tool 6 as described above. For example, the connection tool 6 may be a blood collection tool provided with a blood collection needle at the other end. When the connection tool 6 is the blood collection tool, the blood collection needle is inserted into a vein of a body, and the connector portion 62 is connected to the first plug portion 3A. Then, when the plunger 5 is pulled out to the second side x2 in the first direction, the blood flows into the first space S1 directly from the body (located outside), for example, so that the blood can be collected.

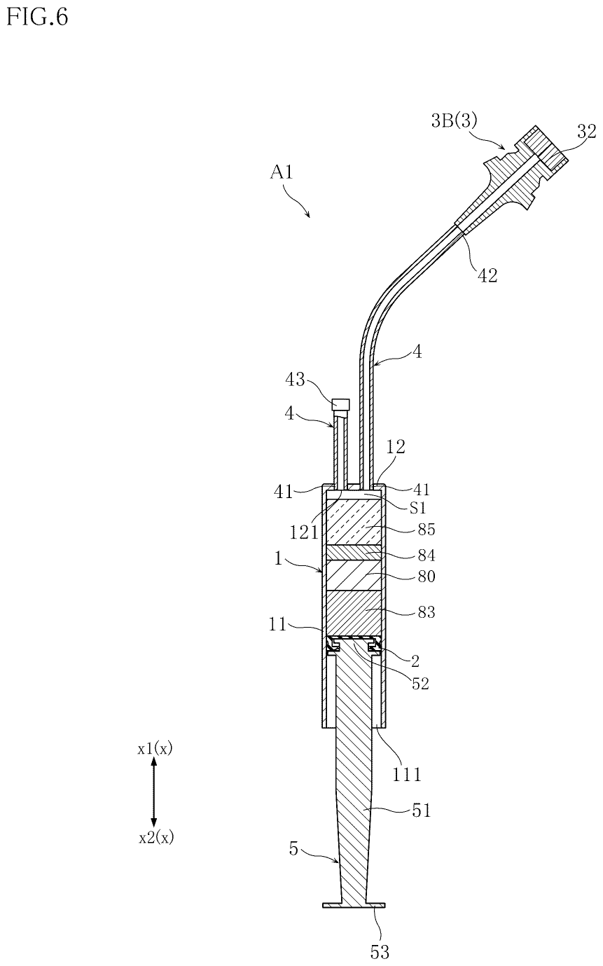

FIG. 5 shows blood 82 collected into the inside (the first space S1) of the container body 1. After the blood 82 is collected in the container body 1, the connector portion 62 of the connection tool 6 is removed from the first plug portion 3A (the first connecting portion 31). As a result, the first connecting portion 31 is closed, and the first space S1 is disconnected from Next, the passage tube 4 connected to the first plug portion 3A is heat-sealed and closed to form a sealed portion 43, and the first plug portion 3A is removed (see FIG. 6). Then, the liquid collection container A1 is set in a centrifugal machine, for example, and is subjected to centrifugal separation. When the liquid collection container A1 is subjected to centrifugal separation, the blood components are separated, and as shown in FIG. 6, red blood cells 83, the density gradient medium 80, white blood cells including mononuclear cells 84, and plasma 85 are stacked in this order from the second side x2 in the first direction relative to the gasket 2, in the first space S1 of the liquid collection container A1. The liquid collection container A1 that has gone through the centrifugal separation process is kept in the posture where the container body 1 is substantially vertical so as to maintain the state where the blood components are stacked as shown in FIG. 6.

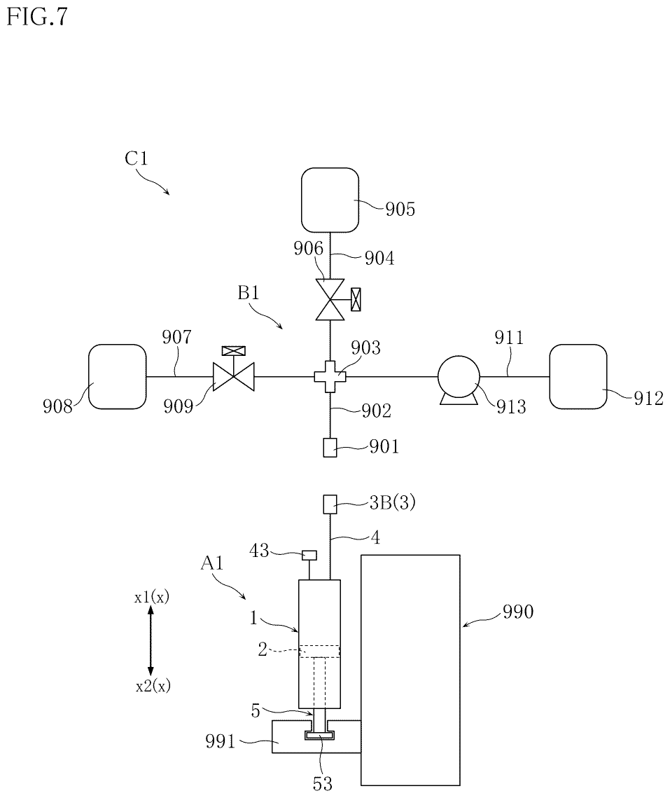

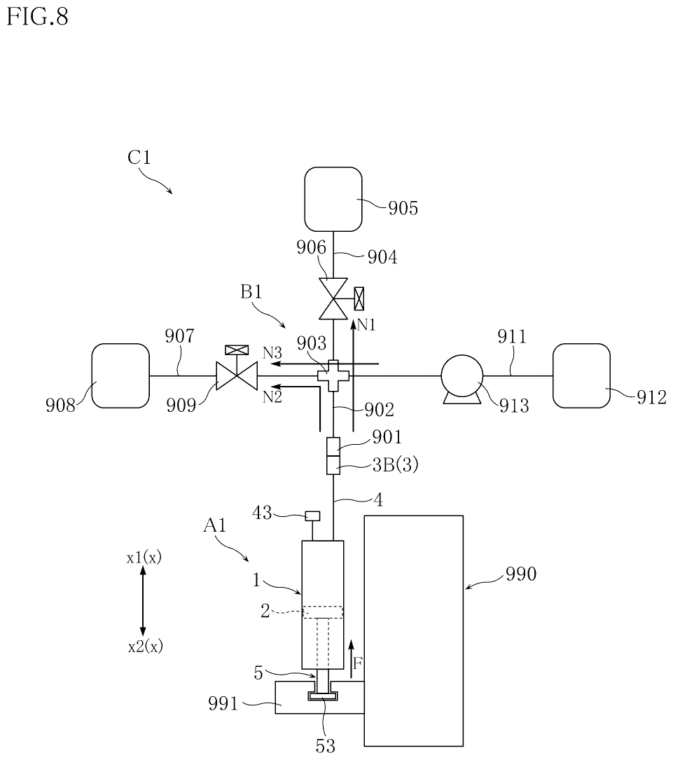

Next, as shown in FIGS. 7 and 8, a liquid component extraction system C1 is used to collect some of the blood components in the container body 1. The present embodiment will be described with an example of collecting the white blood cells including mononuclear cells 84 in the container body 1. The mononuclear cells will be the raw materials of iPS cells for regenerative medicine or the like.

FIG. 7 shows the liquid component extraction system C1 according to the first embodiment of the present disclosure. The liquid component extraction system C1 includes the liquid collection container A1, a liquid component extraction unit B1, and a power function unit 990, and extracts the liquid components in the container body 1 (the liquid collection container A1).

The liquid component extraction unit B1 (the liquid component extraction system C1) includes a second plug portion 901, a first passage 902, a joint portion 903, a second passage 904, a first liquid storage container 905, a first valve 906, a third passage 907, a second liquid storage container 908, a second valve 909, a fourth passage 911, a sterile air supply member 912, and a pump function unit 913, and is configured so that these elements are connected in a closed manner. Each of the first passage 902, the second passage 904, the third passage 907, and the fourth passage 911 is a tube made of a flexible material, for example.

The second plug portion 901 is connectable to the first plug portion 3B of the liquid collection container A1. One end of the first passage 902 is connected to the second plug portion 901. When the second plug portion 901 is connected to the first plug portion 3B, the inside of the container body 1 and the first passage 902 come into communication with each other. The other end of the first passage 902 is connected to the joint portion 903. In the present embodiment, the joint portion 903 is a four-way joint, for example, to which one end of each of the first passage 902, the second passage 904, the third passage 907, and the fourth passage 911 is connected. The joint portion 903 allows the first passage 902, the second passage 904, the third passage 907, and the fourth passage 911 to be in communication with each other.

The second passage 904 is connected to the joint portion 903 at one end, and leads to the first passage 902 via the joint portion 903. The other end of the second passage 904 is connected to the first liquid storage container 905. In the present embodiment, the first liquid storage container 905 is used to store the plasma 85 (a first component) in the first space S1 of the container body 1. The first liquid storage container 905 is preferably flexible, and is configured to be capable of changing its volume. An example of such a first liquid storage container 905 is a film-like bag. The first valve 906 is provided in the second passage 904. The first valve 906 is an on-off valve capable of switching the second passage 904 between an open state and a closed state.

The third passage 907 is connected to the joint portion 903 at one end, and leads to the first passage 902 via the joint portion 903. The other end of the third passage 907 is connected to the second liquid storage container 908. In the present embodiment, the second liquid storage container 908 is used to store the white blood cells including mononuclear cells 84 (second components) in the first space S1 of the container body 1. The second liquid storage container 908 may store in advance vectors incorporating factors necessary to establish iPS cells. The second liquid storage container 908 is preferably flexible, and is configured to be capable of changing its volume. An example of such a second liquid storage container 908 is a film-like bag. The second valve 909 is provided in the third passage 907. The second valve 909 is an on-off valve capable of switching the third passage 907 between an open state and a closed state. Although not illustrated, the second liquid storage container 908 can be connected to a culture vessel in a closed state, and the fluid in the second liquid storage container 908 can be sent to the culture vessel.

Note that the types of the first valve 906 and the second valve 909 are not particularly limited. Each of the first valve 906 and the second valve 909 is a pinch valve, for example. Each of the pinch valves pinches the passage 904 or 907 which is made of a tube, and closes the passage. Each of the first valve 906 and the second valve 909 (the pinch valves) may be electrically or manually operated.

The fourth passage 911 is connected to the joint portion 903 at one end, and leads to the second passage 904 and the third passage 907 via the joint portion 903. The other end of the fourth passage 911 is connected to the sterile air supply member 912. In the present embodiment, the sterile air supply member 912 stores sterile air in advance. The sterile air supply member 912 is flexible, for example, and is configured to be capable of changing its volume. Examples of such a sterile air supply member 912 are a three-dimensional bag and a bellows bag. The sterile air supply member 912 may be a vent filter, instead of a container such as the three-dimensional bag or the bellows bag. This makes it possible to sterilize the air that flows from the outside into the fourth passage 911 via the vent filter. The pump function unit 913 is provided in the fourth passage 911. The pump function unit 913 is used to send sterile air from the sterile air supply member 912 to one of the second passage 904 and the third passage 907 via the fourth passage 911 and the joint portion 903. The pump function unit 913 is a suction pump, for example.

The power function unit 990 moves the gasket 2 to the first side x1 in the first direction by applying a force for pushing and pulling the plunger 5 of the liquid collection container A1. The power function unit 990 includes a movable portion 991. The movable portion 991 is engaged with the trailing end portion 53 of the plunger 5. The power function unit 990 is configured as actuator, for example, which is driven to move the movable portion 991 to the first side x1 in the first direction. This allows the plunger 5 and the gasket 2 connected thereto to be pushed to the first side x1 in the first direction.

Next, a method for collecting the liquid components in the liquid collection container A1 (the container body 1) with use of the liquid component extraction system C1 will be described with reference to FIG. 8.

First, the second plug portion 901 of the liquid component extraction unit B1 (the liquid component extraction system C1) is connected to the first plug portion 3B of the liquid collection container A1. As a result, the first space S1 located on the first side x1 in the first direction relative to the gasket 2 of the liquid collection container A1 communicates with the first passage 902. Note that the first space S1 is kept in a closed state by the gasket 2. Each of the first valve 906 and the second valve 909 of the liquid component extraction unit B1 is placed in a closed state in advance.

Next, the first valve 906 is opened, and the power function unit 990 is activated. The activation of the power function unit 990 causes the movable portion 991 to move to the first side x1 in the first direction at a constant low speed, for example, which results in the gasket 2 moving to the first side x1 in the first direction. Then, the plasma 85 located at the end of the first space S1 on the first side x1 in the first direction flows through the passage tube 4, the first passage 902, and the joint portion 903 to the second passage 904, and is sent to the first liquid storage container 905. The flow of the plasma 85 is indicated by an arrow N1 in FIG. 8. In this way, the plasma 85 (the first component), which is an unnecessary component, is stored in the first liquid storage container 905. When almost all of the plasma 85 has flowed into the second passage 904, the first valve 906 is closed.

Next, the second valve 909 is opened. With the operation of the power function unit 990, the gasket 2 in the container body 1 further moves to the first side x1 in the first direction. Then, the white blood cells including mononuclear cells 84 in the first space S1 flow through the passage tube 4, the first passage 902, and the joint portion 903 to the third passage 907, and are sent to the second liquid storage container 908. The flow of the white blood cells including mononuclear cells 84 is indicated by an arrow N2 in FIG. 8. In this way, the white blood cells including mononuclear cells 84 (the second components), which are necessary components, are stored in the second liquid storage container 908. When almost all of the white blood cells including mononuclear cells 84 have flowed into the third passage 907, the power function unit 990 is stopped.

Next, the pump function unit 913 is activated. As a result, the sterile air in the sterile air supply member 912 flows through the fourth passage 911 and the joint portion 903 to the third passage 907, and is sent to the second liquid storage container 908. The flow of the sterile air is indicated by an arrow N3 in FIG. 8. The white blood cells including mononuclear cells 84 that remain in the joint portion 903 and the third passage 907 are pushed by the sterile air and sent to the second liquid storage container 908. When the sterile air has flowed into almost the entirety of the third passage 907, the pump function unit 913 is stopped and the second valve 909 is closed.

In the second liquid storage container 908, the vectors stored in advance are mixed with the white blood cells including mononuclear cells 84 that are sent from the liquid collection container A1. After a predetermined time has elapsed, a non-illustrated culture vessel is connected to the second liquid storage container 908, the second valve 909 is opened and the pump function unit 913 is activated. As a result, the fluid (the mixture of the vectors and the white blood cells including mononuclear cells 84) in the second liquid storage container 908 is pushed by the sterile air supplied from the sterile air supply member 912 via the third passage 907, and is sent to the culture vessel located on the downstream side. When the fluid in the second liquid storage container 908 has been sent to the culture vessel, the pump function unit 913 is stopped and the second valve 909 is closed. This completes the process of collecting the liquid components in the liquid collection container A1 (the container body 1) by using the liquid component extraction system C1.

In the liquid collection container A1, the gasket 2 is fitted in the first cylindrical portion 11 of the container body 1, as shown in FIGS. 2 and 3. The gasket 2 is in close contact with the inner peripheral surface of the first cylindrical portion 11 without any gaps in the circumferential direction, thereby forming the first space S1 inside the container body 1 on the first side x1 in the first direction. The closure wall 12 and at least a pair of a first plug portion 3 and a passage tube 4 (the first switching portion) are provided at the end of the first cylindrical portion 11 on the first side x1 in the first direction. The closure wall 12, the first plug portion 3 and the passage tube 4 can be switched between a state where the first space S1 communicates with the outside and a state where the first space S1 does not communicate with the outside. With this configuration, when the connector portion 62 is connected to the first plug portion 3A (the first connecting portion 31), blood (a liquid) can be allowed to flow from a blood bag (outside) to the first space S1 while maintaining a closed state.

After the blood components in the first space S1 are separated, the liquid components in the liquid collection container A1 (the container body 1) can be extracted by the liquid component extraction system C1 that includes the liquid collection container A1, the liquid component extraction unit B1, and the power function unit 990, as described with reference to FIGS. 7 and 8, for example.

The liquid component extraction unit B1 (the liquid component extraction system C1) includes the second plug portion 901, the first passage 902, the joint portion 903, the second passage 904, the first liquid storage container 905, the first valve 906, the third passage 907, the second liquid storage container 908, the second valve 909, the fourth passage 911, the sterile air supply member 912, and the pump function unit 913, and these elements are connected in a closed manner. The second plug portion 901 is connectable to the first plug portion 3B of the liquid collection container A1. One end of the first passage 902 is connected to the second plug portion 901. The other end of the first passage 902 is connected to the joint portion 903. The second passage 904 is connected to the joint portion 903 at one end, and leads to the first passage 902 via the joint portion 903. The other end of the second passage 904 is connected to the first liquid storage container 905. The first liquid storage container 905 is used to store the plasma 85 (the first component), which is an unnecessary component in the first space S1 of the container body 1. The first valve 906 is provided in the second passage 904. The third passage 907 is connected to the joint portion 903 at one end, and leads to the first passage 902 via the joint portion 903. The other end of the third passage 907 is connected to the second liquid storage container 908. The second liquid storage container 908 is used to store the white blood cells including mononuclear cells 84 (the second components), which are necessary components in the first space S1 of the container body 1. The second valve 909 is provided in the third passage 907. The liquid component extraction system C1 further includes the power function unit 990. The power function unit 990 moves the gasket 2 to the first side x1 in the first direction by applying a force for pushing and pulling the plunger 5 of the liquid collection container A1. This configuration makes it possible to separate the white blood cells including mononuclear cells 84 (the second components), which are necessary components in the first space S1, from the plasma 85 (the first component), which is an unnecessary component in the first space S1, and to extract these components in a closed state without opening the container body 1, by activating the power function unit 990 appropriately and switching the first valve 906 and the second valve 909 between an open state and a closed state appropriately as described above.

The liquid component extraction unit B1 (the liquid component extraction system C1) includes the fourth passage 911, the sterile air supply member 912, and the pump function unit 913. The fourth passage 911 is connected to the joint portion 903 at one end, and leads to the second passage 904 and the third passage 907 via the joint portion 903. The other end of the fourth passage 911 is connected to the sterile air supply member 912. The sterile air supply member 912 stores sterile air. The pump function unit 913 is provided in the fourth passage 911. The pump function unit 913 sends sterile air from the sterile air supply member 912 to one of the second passage 904 and the third passage 907 via the fourth passage 911 and the joint portion 903. With this configuration, the white blood cells including mononuclear cells 84 that remain in the joint portion 903 and the third passage 907 are pushed away by the sterile air, and are sent to the second liquid storage container 908. In this way, even if the number of white blood cells including mononuclear cells 84 (second components), which are necessary components to be collected, is small, the necessary components can be collected efficiently. In addition, according to the configuration described above, the plasma 85 remaining in the joint portion 903 and the second passage 904 can be sent to the first liquid storage container 905. This makes it possible to prevent the plasma 85 (the first component), which is an unnecessary component, from being mixed with the white blood cells including mononuclear cells 84 (the second components), which are necessary components, and to collect the mononuclear cells efficiently.

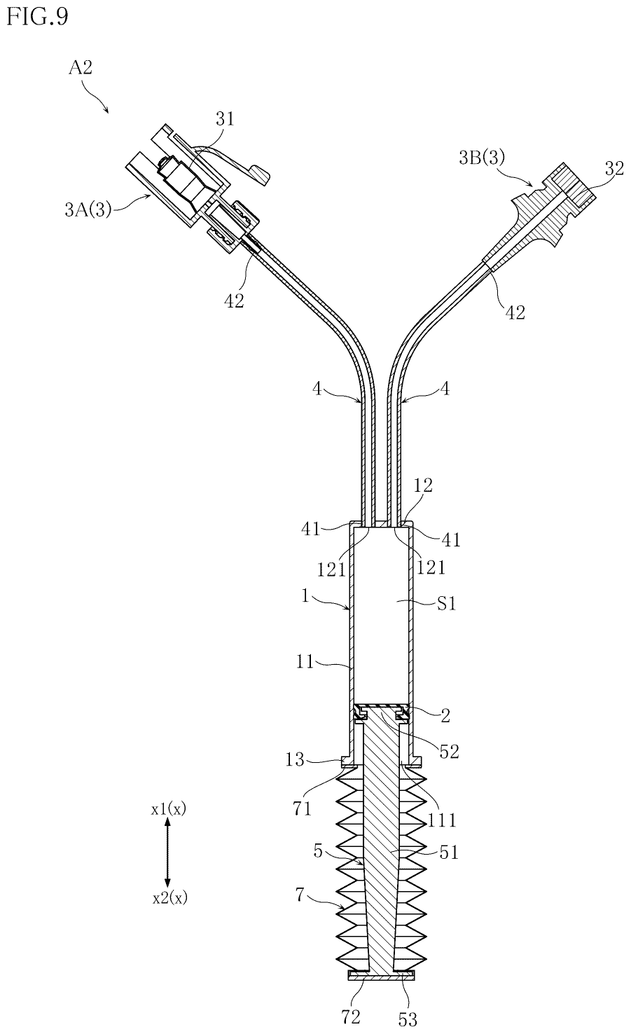

FIG. 9 shows a liquid collection container according to a second embodiment of the present disclosure. The liquid collection container A2 according to the present embodiment is greatly different from the liquid collection container A1 according to the above embodiment in further including an outer casing 7. In FIG. 9 and the subsequent figures, elements that are the same as or similar to those of the liquid collection container A1 according to the above embodiment are provided with the same reference numerals as in the above embodiment, and descriptions thereof are omitted.

The outer casing 7 shields at least the opening 111 at the end of the first cylindrical portion 11 on the second side x2 in the first direction from the outside. The outer casing 7 is flexible and capable of sliding the plunger 5 in the first direction x with a force for pushing and pulling the plunger 5 applied from outside the outer casing 7. In the present embodiment, the outer casing 7 has a front end portion 71 and a rear end portion 72 which are connected by a bellows. The front end portion 71 is located at the end of the outer casing 7 on the first side x1 in the first direction, and the rear end portion 72 is located at the end of the outer casing 7 on the second side x2 in the first direction. In the present embodiment, a flange 13 is provided at the end of the first cylindrical portion 11 on the first side x1 in the first direction. The front end portion 71 of the outer casing 7 is hermetically bonded to the flange 13. The trailing end portion 53 of the plunger 5 is hermetically bonded to the rear end portion 72 (the end of the outer casing 7 on the second side x2 in the first direction). As a result, the inner space of the outer casing 7 is not in communication with the outside. Thus, the opening 111 at the end of the first cylindrical portion 11 on the second side x2 in the first direction is shut off from the outside. As such, the sterility of the container body 1 is maintained properly.

In the liquid collection container A2, the gasket 2 is fitted in the first cylindrical portion 11 of the container body 1. The gasket 2 is in close contact with the inner peripheral surface of the first cylindrical portion 11 without any gaps in the circumferential direction, thereby forming the first space S1 inside the container body 1 on the first side x1 in the first direction. The closure wall 12 and at least a pair of a first plug portion 3 and a passage tube 4 (the first switching portion) are provided at the end of the first cylindrical portion 11 on the first side x1 in the first direction. The closure wall 12, the first plug portion 3 and the passage tube 4 can be switched between a state where the first space S1 communicates with the outside and a state where the first space S1 does not communicate with the outside. With this configuration, when the connector portion 62 is connected to the first plug portion 3A (the first connecting portion 31), blood (a liquid) can be allowed to flow from a blood bag (outside) to the first space S1 while maintaining a closed state.

After the blood components in the first space S1 are separated, the liquid components in the liquid collection container A2 (the container body 1) can be extracted by a liquid component extraction system that includes the liquid collection container A2, the liquid component extraction unit B1 described with reference to FIGS. 7 and 8, for example, in relation to the liquid component extraction system C1 according to the first embodiment, and the power function unit 990. Such a liquid component extraction system has advantages similar the liquid component extraction system C1 according to the first embodiment described with reference to FIGS. 7 and 8.

The liquid collection container A2 according to the present embodiment can further assure its sterility. This makes it possible to lower the cleanliness level of use environment in the application of the present disclosure and other applications, and to reduce the cost of cell production by eliminating the needs of facilities such as an isolator. Preferable applications other than the application in the present disclosure include the collection of a sample from a cell culture vessel, and the addition or replacement of a culture medium component.

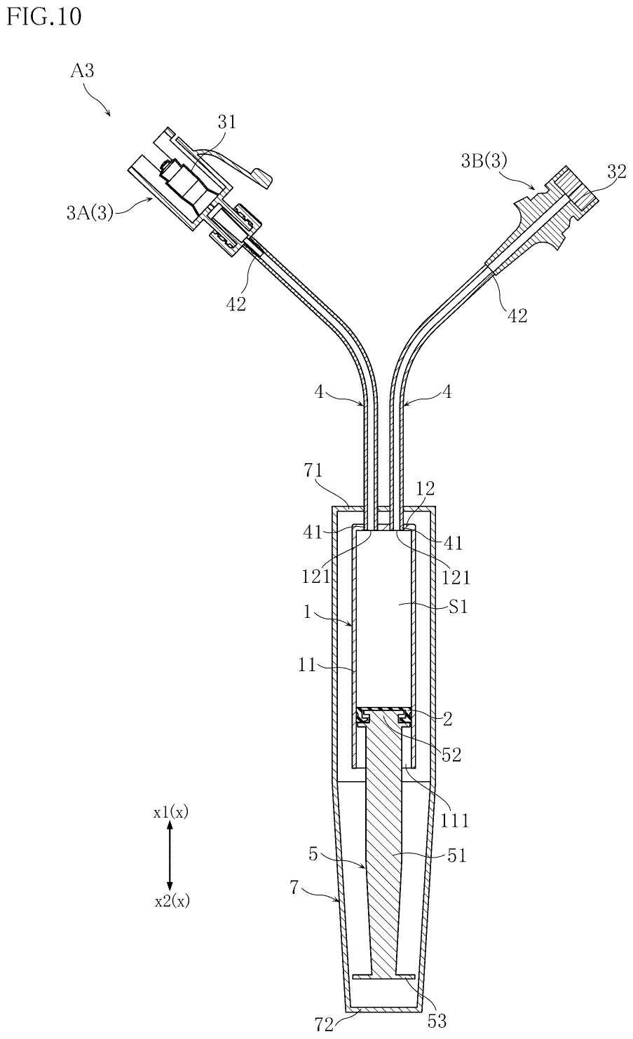

FIG. 10 shows a liquid collection container according to a third embodiment of the present disclosure. The liquid collection container A3 according to the present embodiment is greatly different from the liquid collection container A1 according to the above embodiment in further including an outer casing 7.

The outer casing 7 shields at least the opening 111 at the end of the first cylindrical portion 11 on the second side x2 in the first direction from the outside. The outer casing 7 is flexible and capable of sliding the plunger 5 in the first direction x with a force for pushing and pulling the plunger 5 applied from outside the outer casing 7. In the present embodiment, the outer casing 7 is a film-like bag. The outer casing 7 has a front end portion 71 and a rear end portion 72. A pair of passage tubes 4 are inserted through the front end portion 71. The passage tubes 4 and the front end portion 71 are bonded in close contact with each other. The rear end portion 72 is located near the trailing end portion 53 of the plunger 5, and is closed. As a result, the inner space of the outer casing 7 is not in communication with the outside. Thus, the opening 111 at the end of the first cylindrical portion 11 on the second side x2 in the first direction is shut off from the outside. As such, the sterility of the container body 1 is maintained properly.

In the liquid collection container A3, the gasket 2 is fitted in the first cylindrical portion 11 of the container body 1. The gasket 2 is in close contact with the inner peripheral surface of the first cylindrical portion 11 without any gaps in the circumferential direction, thereby forming the first space S1 inside the container body 1 on the first side x1 in the first direction. The closure wall 12 and at least a pair of a first plug portion 3 and a passage tube 4 (the first switching portion) are provided at the end of the first cylindrical portion 11 on the first side x1 in the first direction. The closure wall 12, the first plug portion 3 and the passage tube 4 can be switched between a state where the first space S1 communicates with the outside and a state where the first space S1 does not communicate with the outside. With this configuration, when the connector portion 62 is connected to the first plug portion 3A (the first connecting portion 31), blood (a liquid) can be allowed to flow from a blood bag (outside) to the first space S1 while maintaining a closed state.

After the blood components in the first space S1 are separated, the liquid components in the liquid collection container A3 (the container body 1) can be extracted by a liquid component extraction system that includes the liquid collection container A3, the liquid component extraction unit B1 described with reference to FIGS. 7 and 8, for example, in relation to the liquid component extraction system C1 according to the first embodiment, and the power function unit 990. Such a liquid component extraction system has advantages similar the liquid component extraction system C1 according to the first embodiment described with reference to FIGS. 7 and 8.

The liquid collection container A3 according to the present embodiment can further assure its sterility. This makes it possible to lower the cleanliness level of use environment in the application of the present disclosure and other applications, and to reduce the cost of cell production by eliminating the needs of facilities such as an isolator. Preferable applications other than the application in the present disclosure include the collection of a sample from a cell culture vessel, and the addition or replacement of a culture medium component.

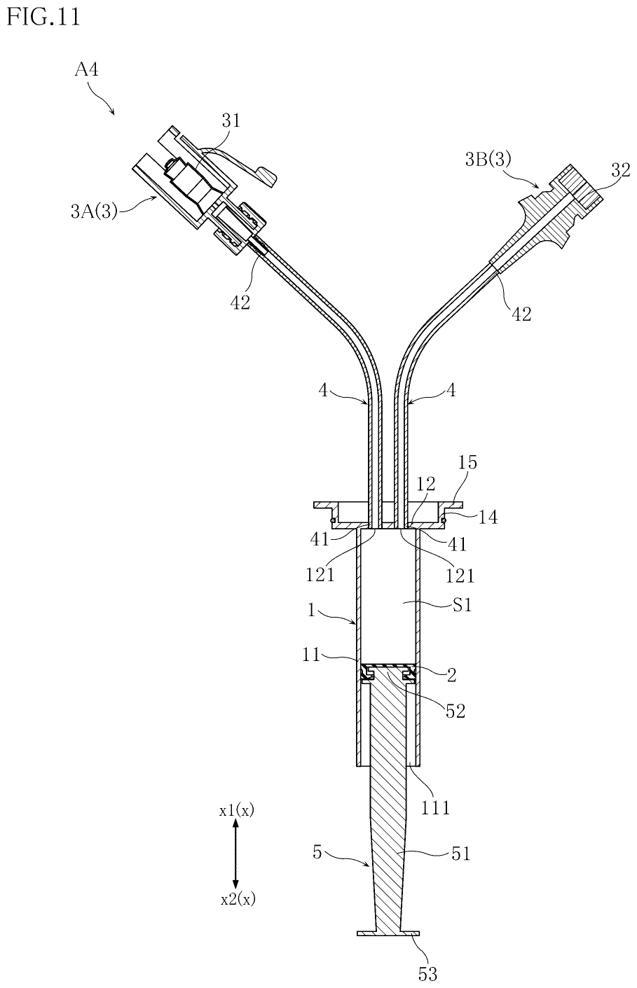

FIG. 11 shows a liquid collection container according to a fourth embodiment of the present disclosure. A liquid collection container A4 according to the present embodiment is different from the liquid collection container A1 according to the above embodiment in the configuration of the container body 1.

In the present embodiment, the container body 1 has a second cylindrical portion 14 and a flange 15. The second cylindrical portion 14 is located at the end of the first cylindrical portion 11 on the first side x1 in the first direction, and has a radial dimension larger than that of the first cylindrical portion 11. The flange 15 extends radially outward from the end of the second cylindrical portion 14 on the first side x1 in the first direction.

In the liquid collection container A4, the gasket 2 is fitted in the first cylindrical portion 11 of the container body 1. The gasket 2 is in close contact with the inner peripheral surface of the first cylindrical portion 11 without any gaps in the circumferential direction, thereby forming the first space S1 inside the container body 1 on the first side x1 in the first direction. The closure wall 12 and at least a pair of a first plug portion 3 and a passage tube 4 (the first switching portion) are provided at the end of the first cylindrical portion 11 on the first side x1 in the first direction. The closure wall 12, the first plug portion 3 and the passage tube 4 can be switched between a state where the first space S1 communicates with the outside and a state where the first space S1 does not communicate with the outside. With this configuration, when the connector portion 62 is connected to the first plug portion 3A (the first connecting portion 31), blood (a liquid) can be allowed to flow from a blood bag (outside) to the first space S1 while maintaining a closed state.

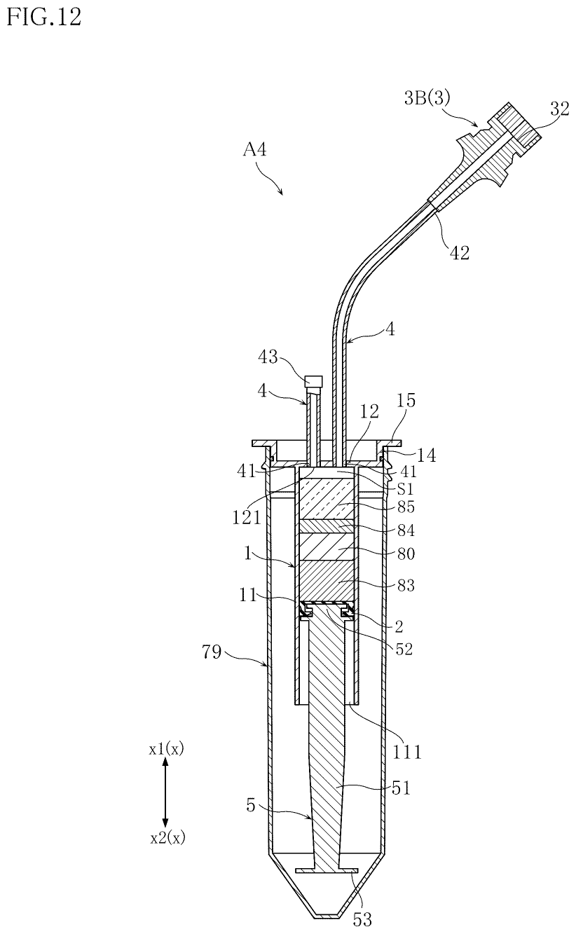

In the liquid collection container A4, the container body 1 has the second cylindrical portion 14 and the flange 15. Such a configuration allows the second cylindrical portion 14 of the container body 1 to be fitted in an opening at the upper end of a centrifuge tube 79 and latched by the flange 15, as shown in FIG. 12, for example. In this way, the liquid collection container A4 is supported by the centrifuge tube 79, and a centrifugal separation process can be easily and appropriately performed by setting the centrifuge tube 79 in a centrifugal machine. It is preferable to provide a means for fixing the first plug portion 3B and the passage tube 4 connected to the first plug portion 3B to a rotor to prevent them from being damaged in a centrifugal separation process.

After the blood components in the first space S1 are separated, the liquid components in the liquid collection container A4 (the container body 1) can be extracted by a liquid component extraction system that includes the liquid collection container A4, the liquid component extraction unit B1 described with reference to FIGS. 7 and 8, for example, in relation to the liquid component extraction system C1 according to the first embodiment, and the power function unit 990. Such a liquid component extraction system has advantages similar the liquid component extraction system C1 according to the first embodiment described with reference to FIGS. 7 and 8.

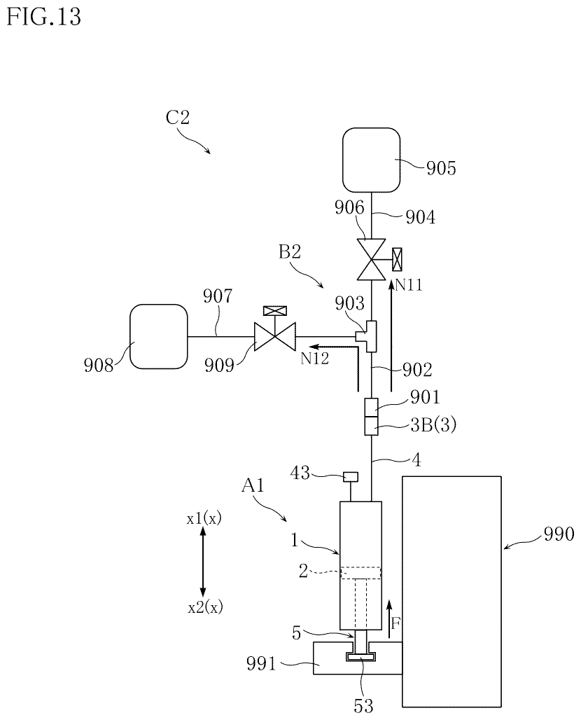

FIG. 13 shows a liquid component extraction system C2 according to the second embodiment of the present disclosure. The liquid component extraction system C2 includes the liquid collection container A1, a liquid component extraction unit B2, and a power function unit 990, and extracts the liquid components in the container body 1 (the liquid collection container A1). In FIG. 13, elements that are the same as or similar to those of the liquid component extraction unit B1 according to the above embodiment are provided with the same reference numerals as in the above embodiment, and descriptions thereof are omitted.

The liquid component extraction unit B2 (the liquid component extraction system C2) includes a third plug portion 901, a first passage 902, a joint portion 903, a second passage 904, a first liquid storage container 905, a first valve 906, a third passage 907, a second liquid storage container 908, and a second valve 909, and these elements are connected in a closed manner.

In the present embodiment, the joint portion 903 is a three-way joint, for example, to which one end of each of the first passage 902, the second passage 904, and the third passage 907 is connected. The joint portion 903 allows the first passage 902, the second passage 904, and the third passage 907 to be in communication with each other.

Next, a method for collecting the liquid components in the liquid collection container A1 (the container body 1) with use of the liquid component extraction system C2 will be described with reference to FIG. 13. The present embodiment will be described with an example of collecting the white blood cells including mononuclear cells 84 in the container body 1. The white blood cells including mononuclear cells 84 will be the raw materials of iPS cells for regenerative medicine or the like.

First, the second plug portion 901 of the liquid component extraction unit B2 (the liquid component extraction system C2) is connected to the first plug portion 3B of the liquid collection container A1. As a result, the first space S1 located on the first side x1 in the first direction relative to the gasket 2 of the liquid collection container A1 communicates with the first passage 902. Note that the first space S1 is kept in a closed state by the gasket 2. Each of the first valve 906 and the second valve 909 is placed in a closed state in advance.

Next, the first valve 906 is opened, and the power function unit 990 is activated. The activation of the power function unit 990 causes the movable portion 991 to move to the first side x1 in the first direction at a constant low speed, for example, which results in the gasket 2 moving to the first side x1 in the first direction. Then, the plasma 85 located at the end of the first space S1 on the first side x1 in the first direction flows through the passage tube 4, the first passage 902, and the joint portion 903 to the second passage 904, and is sent to the first liquid storage container 905. The flow of the plasma 85 is indicated by an arrow N11 in FIG. 13. In this way, the plasma 85 (the first component), which is an unnecessary component, is stored in the first liquid storage container 905. When almost all of the plasma 85 has flowed into the second passage 904, the first valve 906 is closed.

Next, the second valve 909 is opened. With the operation of the power function unit 990, the gasket 2 in the container body 1 further moves to the first side x1 in the first direction. Then, the white blood cells including mononuclear cells 84 in the first space S1 flow through the passage tube 4, the first passage 902, and the joint portion 903 to the third passage 907, and are sent to the second liquid storage container 908. The flow of the white blood cells including mononuclear cells 84 is indicated by an arrow N12 in FIG. 13. In this way, the white blood cells including mononuclear cells 84 (the second components), which are necessary components, are stored in the second liquid storage container 908. When almost all of the white blood cells including mononuclear cells 84 have flowed into the second liquid storage container 908, the power function unit 990 is stopped and the second valve 909 is closed. This completes the process of collecting the liquid components in the liquid collection container A1 (the container body 1) by using the liquid component extraction system C2.

The liquid component extraction unit B2 (the liquid component extraction system C2) includes the second plug portion 901, the first passage 902, the joint portion 903, the second passage 904, the first liquid storage container 905, the first valve 906, the third passage 907, the second liquid storage container 908, and the second valve 909, and these elements are connected in a closed manner. The second plug portion 901 is connectable to the first plug portion 3B of the liquid collection container A1. One end of the first passage 902 is connected to the second plug portion 901. The other end of the first passage 902 is connected to the joint portion 903. The second passage 904 is connected to the joint portion 903 at one end, and leads to the first passage 902 via the joint portion 903. The other end of the second passage 904 is connected to the first liquid storage container 905. The first liquid storage container 905 is used to store the plasma 85 (the first component), which is an unnecessary component in the first space S1 of the container body 1. The first valve 906 is provided in the second passage 904. The third passage 907 is connected to the joint portion 903 at one end, and leads to the first passage 902 via the joint portion 903. The other end of the third passage 907 is connected to the second liquid storage container 908. The second liquid storage container 908 is used to store the white blood cells including mononuclear cells 84 (the second components), which are necessary components in the first space S1 of the container body 1. The second valve 909 is provided in the third passage 907. The liquid component extraction system C2 further includes the power function unit 990. The power function unit 990 moves the gasket 2 to the first side x1 in the first direction by applying a force for pushing and pulling the plunger 5 of the liquid collection container A1. This configuration makes it possible to separate the white blood cells including mononuclear cells 84 (the second components), which are necessary components in the first space S1, from the plasma 85 (the first component), which is an unnecessary component in the first space S1, and to extract these components in a closed state without opening the container body 1, by activating the power function unit 990 appropriately and switching the first valve 906 and the second valve 909 between an open state and a closed state appropriately as described above.

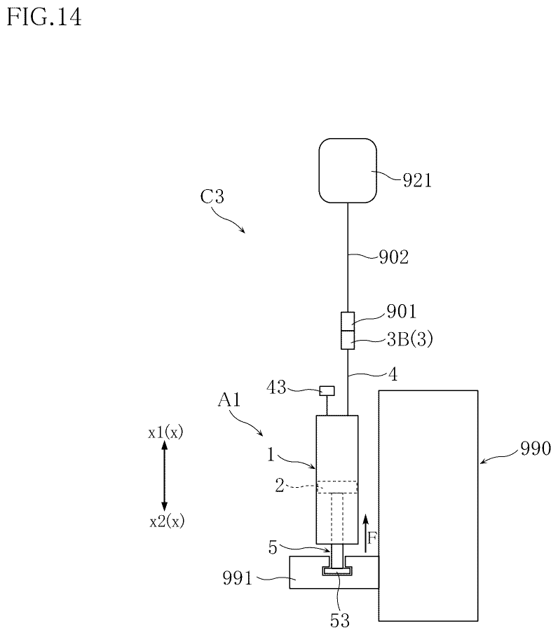

FIG. 14 shows a liquid component extraction system C3 according to a third embodiment of the present disclosure. The liquid component extraction system C3 includes the liquid collection container A1 and elements described below, and extracts the liquid components in the container body 1 (the liquid collection container A1). In the present embodiment, the first space S1 in the container body 1 (the liquid collection container A1) may store blood, for example. In the present embodiment, blood collected from a human body is stored directly in the first space S1 of the container body 1 without being separated into blood components by centrifugal separation.

The liquid component extraction system C3 includes the liquid collection container A1, a second plug portion 901, a first passage 902, and a liquid storage container 921, and these elements are connected in a closed manner. The first passage 902 is a tube made of a flexible material, for example. The liquid component extraction system C3 further includes a power function unit 990.

The second plug portion 901 is connected to the first plug portion 3B of the liquid collection container A1. One end of the first passage 902 is connected to the second plug portion 901. This allows the inside of the container body 1 and the first passage 902 to be in communication with each other. The other end of the first passage 902 is connected to the liquid storage container 921.

In the present embodiment, the liquid storage container 921 is used to store the blood located in the first space S1 of the container body 1. The liquid storage container 921 may store in advance vectors incorporating factors necessary to establish iPS cells. The liquid storage container 921 is preferably flexible, and is configured to be capable of changing its volume. An example of such a liquid storage container 921 is a film-like bag.

Next, a method for collecting the liquid component in the liquid collection container A1 (the container body 1) with use of the liquid component extraction system C3 will be described. The present embodiment will be described with an example of collecting the blood in the container body 1. A particular component (e.g., white blood cells including mononuclear cells) in the blood will be the raw material of an iPS cell for regenerative medicine or the like.

The second plug portion 901 is connected to the first plug portion 3B of the liquid collection container A1. As a result, the first space S1 located on the first side x1 in the first direction relative to the gasket 2 of the liquid collection container A1 communicates with the first passage 902.

Next, the power function unit 990 is activated. The activation of the power function unit 990 causes the movable portion 991 to move to the first side x1 in the first direction at a constant low speed, for example, which results in the gasket 2 moving to the first side x1 in the first direction. The blood in the first space S1 flows to the first passage 902 via the passage tube 4, and is sent to the liquid storage container 921. In this way, the blood in the container body 1 is stored in the liquid storage container 921. When an appropriate amount of blood has been stored in the liquid storage container 921, the power function unit 990 is stopped. This completes the process of collecting the liquid component (blood) in the liquid collection container A1 (the container body 1) by using the liquid component extraction system C3.

The liquid component extraction system C3 includes the second plug portion 901, the first passage 902, and the liquid storage container 921, and these elements are connected in a closed manner. The second plug portion 901 is connectable to the first plug portion 3B of the liquid collection container A1. One end of the first passage 902 is connected to the second plug portion 901. The other end of the first passage 902 is connected to the liquid storage container 921. The liquid storage container 921 is used to store the liquid component (blood) in the first space S1 of the container body 1. The liquid component extraction system C3 further includes the power function unit 990. The power function unit 990 moves the gasket 2 to the first side x1 in the first direction by applying a force for pushing and pulling the plunger 5 of the liquid collection container A1. This configuration makes it possible to extract the liquid component (blood) in the first space S1 in a closed state without opening the container body 1, by activating the power function unit 990.

Although specific embodiments of the present disclosure have been described, the liquid collection container and the liquid component extraction system according to the present disclosure are not limited to the above embodiments. Various design changes can be made to the specific configurations of the elements of each of the liquid collection container and the liquid component extraction system according to the present disclosure.

The use of the liquid collection container according to the present disclosure is not particularly limited, and it can be used for purposes other than separating and collecting mononuclear cells from blood. For example, the liquid collection container is also suitable for separating and collecting plasma or platelet-rich plasma (PRP).

According to the above embodiments, a layer of white blood cell components including desired mononuclear cells is obtained by prefilling the density gradient medium 80 in the first space S1 of the container body 1, pouring blood in the first space S1, and subjecting the container body 1 to centrifugal separation. However, the present disclosure is not limited to this. The liquid collection container according to the present disclosure may be configured such that the first space of the container body is further prefilled with a float member or a gel agent having a density between the density of red blood cells and the density of plasma, making it more difficult for the white blood cell component layer to mix with other layers.

In addition, the liquid collection container according to the present disclosure does not necessarily require the centrifugal separation process. For example, when iPS cells are to be established, the liquid collection container can be used to collect blood and mix the blood as is with vectors or the like without subjecting the blood to centrifugal separation. Even in this case, it is possible to fully enjoy the advantage of performing tasks while completely maintaining a closed system.

The liquid collected into the container body is not limited to blood and may be fat cells.

The above embodiments have been described with an example where a first plug portion (3A or 3B) is connected by a connector, but the connecting structure of the first plug portion is not particularly limited. In the present disclosure, the first plug portion may be a tube or a connector portion connected to the tube, and may be connected to another tube or another connector portion connected to the tube in a sterilized manner by means of, for example, welding.

The above embodiments have given an example of a closure portion of the present disclosure, which is the closure wall 12 of the container body 1, and the closure wall 12 closes the end of the first cylindrical portion 11 on the first side x1 in the first direction. However, the present disclosure is not limited to this. For example, the first cylindrical portion 11 may have an open end on the first side x1 in the first direction, and a plug member (made of rubber, for example) as a closure portion may be pressed into the open end so as to close the end of the first cylindrical portion 11 on the first side x1 in the first direction. In this case, the plug member may be formed with a communication hole, and the first end portion 41 of a passage tube 4 may be connected to the plug member in a state where the first end portion 41 is in communication with the first space S1 via the communication hole.

The present disclosure includes the configurations relating to the following clauses.

### Clause 1

A liquid collection container comprising:
a container body including a first cylindrical portion that extends in a first direction;
a gasket that is in close contact with an inner peripheral surface of the first cylindrical portion without any gaps in a circumferential direction, thereby forming a first space inside the container body;
a first switching portion located at an end of the first cylindrical portion on a first side in the first direction and switchable between a state where the first space communicates with an outside and a state where the first space does not communicate with the outside; and
a plunger connected to the gasket, extending from an opening of the first cylindrical portion at an end on a second side in the first direction to the second side in the first direction, and capable of applying a force for sliding the gasket in the first direction,
wherein the first switching portion includes a closure portion and at least a pair of a first plug portion and a passage tube,
the closure portion closes the end of the first cylindrical portion on the first side in the first direction, and includes at least one communication hole penetrating through in the first direction,
the first plug portion includes a first connecting portion that is impermeable with respect to gas and liquid-tight, and
the passage tube includes a first end portion connected to the closure portion in a state where the first end portion is in communication with the communication hole, and a second end portion closed by the first connecting portion.

### Clause 2

The liquid collection container according to clause 1, further comprising an outer casing that shields at least the opening at the end of the first cylindrical portion on the second side in the first direction from the outside,
wherein the outer casing is flexible and capable of sliding the gasket in the first direction with a force for pushing and pulling the plunger applied from outside the outer casing.

### Clause 3

The liquid collection container according to clause 2, wherein the end of the plunger on the second side in the first direction is bonded to an end of the outer casing on the second side in the first direction.

### Clause 4

The liquid collection container according to any of clauses 1 to 3, wherein the container body further includes a second cylindrical portion and a flange, the second cylindrical portion being located at the end of the first cylindrical portion on the first side in the first direction and having a radial dimension larger than a radial dimension of the first cylindrical portion, the flange extending radially outward from an end of the second cylindrical portion on the first side in the first direction.

### Clause 5

The liquid collection container according to clause 4, wherein the first space of the container body stores a density gradient medium.

### Clause 6

A liquid component extraction system configured with elements connected in a closed manner, the liquid component extraction system comprising:
the liquid collection container according to any of clauses 1 to 5;
a power function unit that moves the gasket in the first direction by applying a force for pushing and pulling the plunger of the liquid collection container;
a second plug portion connectable to the first plug portion of the liquid collection container;
a first passage connected to the second plug portion at one end; and
a liquid storage container connected to another end of the first passage and for storing a component located in the first space of the container body.

### Clause 7

A liquid component extraction system configured with elements connected in a closed manner, the liquid component extraction system comprising:
the liquid collection container according to any of clauses 1 to 5;
a power function unit that moves the gasket in the first direction by applying a force for pushing and pulling the plunger of the liquid collection container;
a second plug portion connectable to the first plug portion of the liquid collection container;
a first passage connected to the second plug portion at one end;
a joint portion to which another end of the first passage is connected;
a second passage connected to the joint portion at one end, and leading to the first passage via the joint portion;
a first liquid storage container connected to another end of the second passage and for storing a first component located in the first space of the container body;
a third passage connected to the joint portion at one end, and leading to the first passage via the joint portion;
a second liquid storage container connected to another end of the third passage and for storing a second component located in the first space of the container body;
a first valve provided in the second passage and capable of switching the second passage between an open state and a closed state; and
a second valve provided in the third passage and capable of switching the third passage between an open state and a closed state.

### Clause 8

The liquid component extraction system according to clause 7, further comprising: a fourth passage connected to the joint portion at one end, and leading to the second passage and the third passage via the joint portion;
a sterile air supply member connected to another end of the fourth passage; and
a pump function unit for sending sterile air from the sterile air supply member to one of the second passage and the third passage via the fourth passage and the joint portion.

### REFERENCE NUMERALS

A1, A2, A3, A4: Liquid collection container; B1, B2: Liquid component extraction unit; C1, C2, C3: Liquid component extraction system; 1: Container body; 11: First cylindrical portion; 111: Opening; 12: Closure wall (Closure portion, First switching portion); 121: Communication hole; 13: Flange; 14: Second cylindrical portion; 15: Flange; 2: Gasket; 3, 3A, 3B: First plug portion (First switching portion); 31, 32: First connecting portion; 4: Passage tube (First switching portion); 41: First end portion; 42: Second end portion; 43: Sealed portion; 5: Plunger; 51: Shaft portion; 52: Leading end portion; 53: Trailing end portion; 6: Connection tool; 61: Tube; 62: Connector portion; 7: Outer casing; 71: Front end portion; 72: Rear end portion; 79: Centrifuge tube; 80: Density gradient medium; 82: Blood; 83: Red blood cells; 84: White blood cells including mononuclear cells; 85: Plasma; 901: Second plug portion; 902: First passage; 903: Joint portion; 904: Second passage; 905: First liquid storage container; 906: First valve; 907: Third passage; 908: Second liquid storage container; 909: Second valve; 911: Fourth passage; 912: Sterile air supply member; 921: Liquid storage container; 990: Power function unit; 991: Movable portion; N1, N2, N3, N11, N12: Arrow; S1: First space; x: First direction; x1: First side in a first direction; x2: Second side in a first direction

1. A liquid collection container comprising:
a container body including a first cylindrical portion that extends in a first direction;
a gasket that is in close contact with an inner peripheral surface of the first cylindrical portion without any gaps in a circumferential direction, thereby forming a first space inside the container body;
a first switching portion located at an end of the first cylindrical portion on a first side in the first direction and switchable between a state where the first space communicates with an outside and a state where the first space does not communicate with the outside; and
a plunger connected to the gasket, extending from an opening of the first cylindrical portion at an end on a second side in the first direction to the second side in the first direction, and capable of applying a force for sliding the gasket in the first direction,
wherein the first switching portion includes a closure portion and at least a pair of a first plug portion and a passage tube,
the closure portion closes the end of the first cylindrical portion on the first side in the first direction, and includes at least one communication hole penetrating through in the first direction,
the first plug portion includes a first connecting portion that is impermeable with respect to gas and liquid-tight, and
the passage tube includes a first end portion connected to the closure portion in a state where the first end portion is in communication with the communication hole, and a second end portion closed by the first connecting portion.

2. The liquid collection container according to claim 1, further comprising an outer casing that shields at least the opening at the end of the first cylindrical portion on the second side in the first direction from the outside,
wherein the outer casing is flexible and capable of sliding the gasket in the first direction with a force for pushing and pulling the plunger applied from outside the outer casing.

3. The liquid collection container according to claim 2, wherein the end of the plunger on the second side in the first direction is bonded to an end of the outer casing on the second side in the first direction.

4. The liquid collection container according to claim 1, wherein the container body further includes a second cylindrical portion and a flange, the second cylindrical portion being located at the end of the first cylindrical portion on the first side in the first direction and having a radial dimension larger than a radial dimension of the first cylindrical portion, the flange extending radially outward from an end of the second cylindrical portion on the first side in the first direction.

5. The liquid collection container according to claim 4, wherein the first space of the container body stores a density gradient medium.

6. A liquid component extraction system configured with elements connected in a closed manner, the liquid component extraction system comprising:
the liquid collection container according to claim 1;
a power function unit that moves the gasket in the first direction by applying a force for pushing and pulling the plunger of the liquid collection container;
a second plug portion connectable to the first plug portion of the liquid collection container;
a first passage connected to the second plug portion at one end; and
a liquid storage container connected to another end of the first passage and for storing a component located in the first space of the container body.

7. A liquid component extraction system configured with elements connected in a closed manner, the liquid component extraction system comprising:
the liquid collection container according to claim 1;
a power function unit that moves the gasket in the first direction by applying a force for pushing and pulling the plunger of the liquid collection container;
a second plug portion connectable to the first plug portion of the liquid collection container;
a first passage connected to the second plug portion at one end;
a joint portion to which another end of the first passage is connected;
a second passage connected to the joint portion at one end, and leading to the first passage via the joint portion;
a first liquid storage container connected to another end of the second passage and for storing a first component located in the first space of the container body;
a third passage connected to the joint portion at one end, and leading to the first passage via the joint portion;
a second liquid storage container connected to another end of the third passage and for storing a second component located in the first space of the container body;
a first valve provided in the second passage and capable of switching the second passage between an open state and a closed state; and
a second valve provided in the third passage and capable of switching the third passage between an open state and a closed state.

8. The liquid component extraction system according to claim 7, further comprising: a fourth passage connected to the joint portion at one end, and leading to the second passage and the third passage via the joint portion;
a sterile air supply member connected to another end of the fourth passage; and
a pump function unit for sending sterile air from the sterile air supply member to one of the second passage and the third passage via the fourth passage and the joint portion.
